(19) United States
(12) Patent Application Publication
(10) Pub. No.: US 2006/0226667 A1
(43) Pub. Date: Oct. 12, 2006

(54) Cable lifting basket

(76) Inventor: John Leaverton, Spring Creek, NV (US)

Correspondence Address: THORPE NORTH & WESTERN, LLP., 8180 SOUTH 700 EAST, SUITE 200, SANDY, UT, 84070, US

(21) Appl. No.: 11/086,119

(22) Filed: Mar. 21, 2005

(51) Int. Cl. B66C 1/12

(52) U.S. Cl. 294/74

(57) ABSTRACT

A device and method are provided for a lifting basket. The device can include a horizontal band, configured to maintain a space within the horizontal band. A vertical band can be coupled to the horizontal band so that a space is formed inside the vertical band. In addition, a reinforcing member may be coupled to at least two points of the vertical band and the reinforcing member can cross the space inside the vertical band. A cable grip can be provided that is coupled to the vertical band, below the horizontal band, or directly to the horizontal band.

### FIELD OF THE INVENTION

The present invention relates generally to a lifting basket used for lifting cables.

### BACKGROUND

Electric mining shovels are employed in large scale surface mining operations and move substantial amounts of earth with a massive dipper bucket mounted to the end of a handle, which is supported on a boom. These large mining machines are powered by electric drive motors that hoist and lower the dipper, crowd and retract the handle, swing the revolving boom, and walk the shovel to new locations. Given the size of the equipment, in addition to the weight of the earth being moved, the electric drive motors use a substantial amount of electricity input. Thus, the power cables that supply this electricity are very large and heavy.

There are several techniques for moving these lengthy and heavy power cables. If the mining shovel has to move to a far away location, the shovel is connected to a portable power supply, which follows the shovel while it is walking to the new location. The power cable is then gathered by cable reels or dragged by specially equipped vehicles to the new location. Dragging the cable often causes serious damage to the cable.

Frequently, mining shovels need to move only short distances during the excavation process. A shovel may need to move back and forth along an excavation wall, and as ore is removed, the shovel has to move farther away from the cable source in order to reach the excavation wall. These smaller movements of the mining shovel location take up or provide excess slack in the cable, depending on which way the shovel moves. Thus, periodically, the location of the cable trailing the shovel must be adjusted with respect to the shovel's position. Adjusting the cable location is usually accomplished by dragging the cable behind the shovel, using a take up reel, or manually placing excess cable on a cable sled. These methods are dangerous to the cable and personnel.

Dragging the cable behind the shovel can cause damage to the cable by scraping, cracking, or breaking away protective insulation. Additionally, the cable itself may be broken by the forces needed to move it. The size and weight of the cable make it difficult to repair and damaged cable presents an electrical shock hazard to personnel who handle the cable.

Take up reels have been used, as an alternative to dragging, to prevent cable damage and protect personnel. Powered take-up reels have been attached to shovels to play out cable as the equipment moves forward or take up slack as it retreats. However, cable reels present their own problems because in order to prevent mis-winding on the reel and cable damage from kinking, the collection and distribution of the cable is relatively slow and impedes excavation production. Additionally, cable stored on a reel must have its ampacity reduced to compensate for reduction in radiatory heat loss, thereby affecting power transfer efficiencies.

Less mechanized systems for transporting and storing cables have been developed to overcome the production problems of take up reels such as skid mounted sleds. Sleds are used to store coiled excess cable and eliminate cable damage caused by dragging. However, sleds require cable manhandling to load the cable on the sled and do not eliminate risk to personnel.

Cable lifting devices have been attached to the cable allowing the teeth of the shovel dipper to grab the lifting device and move the cable to a new location. These devices are relatively effective in allowing efficient movement of the cable and minimizing hazards to personnel. However, cable lifting devices are subject to the tremendous destructive forces of the shovel dipper, the weight of the power cable, and the environmental conditions of the mine. Consequently, these lifting devices deteriorate and have a relatively short usable life.

### SUMMARY OF THE INVENTION

A device and method are provided for a lifting basket. The device can include a horizontal band, configured to maintain a space within the horizontal band. A vertical band can be coupled to the horizontal band so that a space is formed inside the vertical band. In addition, a reinforcing member may be coupled to at least two points of the vertical band and the reinforcing member can cross the space inside the vertical band. A cable grip can be provided that is coupled to the vertical band, below the horizontal band, or directly to the horizontal band.

### BRIEF DESCRIPTION OF THE DRAWINGS

Additional features and advantages of the invention will be apparent from the detailed description which follows, taken in conjunction with the accompanying drawings, which together illustrate, by way of example, features of the invention, wherein:

FIG. 1 is a front perspective view of a cable lifting basket in accordance with an embodiment of the present invention;

FIG. 2a is a cross-sectional view of a vertical or horizontal band of the cable lifting basket taken along line 2-2 in FIG. 1 in accordance with an embodiment of the present invention;

FIG. 2b is a cross-sectional view of a composite band with a first and second band segment;

FIG. 3 is a perspective view of a cable lifting basket having a belly band in an embodiment of the invention; and

FIG. 4 is a side perspective view of an embodiment of a lifting basket lifting an electric power cable.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLARY EMBODIMENT(S)

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention. The following detailed description and exemplary embodiments of the invention will be best understood by reference to the accompanying drawings, wherein the elements and features of the invention are designated by numerals throughout.

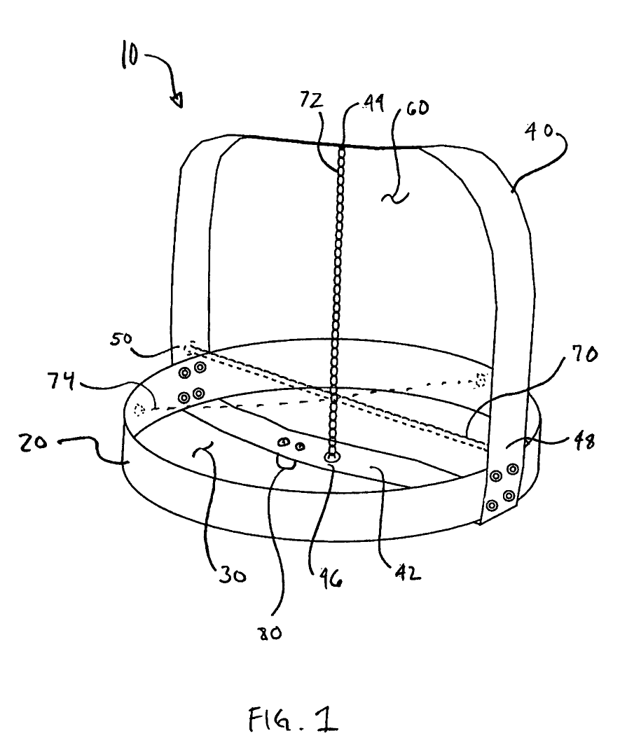

FIG. 1 illustrates a perspective view of an embodiment of a cable lifting basket as shown, generally indicated at 10. Specifically, FIG. 1 illustrates a cable lifting basket including a horizontal band 20 that can maintain a space 30 within the horizontal band. A vertical band 40 can be fastened to the horizontal band so that a space 60 is formed inside the vertical band.

A reinforcing member, such as chain or cable, 70 can be attached to the inside surface 42 of the vertical band 40 so that the reinforcing member can cross the space 60 inside the vertical band. The reinforcing member can be attached on the sides 48 and 50 of the vertical band, and can cross the space inside the vertical band in a plane substantially coincident to the horizontal plane of the horizontal band. The reinforcing member can also be attached at the top 44 and bottom 46 of the vertical band so that the chain crosses the space inside the vertical band in a plane substantially coincident with the vertical plane of the vertical band, as shown by the chain illustration 72 in FIG. 1. The reinforcing member can also be attached to the horizontal band 20 and run through the space 30 within the horizontal band in a substantially coincident plane to the horizontal plane of the horizontal band, as shown by dashed line 74 in FIG. 1.

More than one reinforcing member 70, 72, or 74 can be attached to the lifting basket 10 as needed to maintain the integrity of the shape of the lifting basket. A horizontal reinforcing member 70 and/or 74 may reinforce the vertical band by resisting sagging or collapsing of the vertical band under its own weight when the band is sitting on the ground. A reinforcing member in a vertical orientation 72 can reinforce the vertical band when the cable basket is lifted by resisting stretching of the vertical band.

A cable grip 80 can be attached to the vertical band 40 below the horizontal band 20. The cable grip can attach to a cable so that when the lifting basket 10 is raised, the cable is also lifted at the point the cable grip is attached. The cable grip can be any device suitable for holding a cable as is generally known in the art.

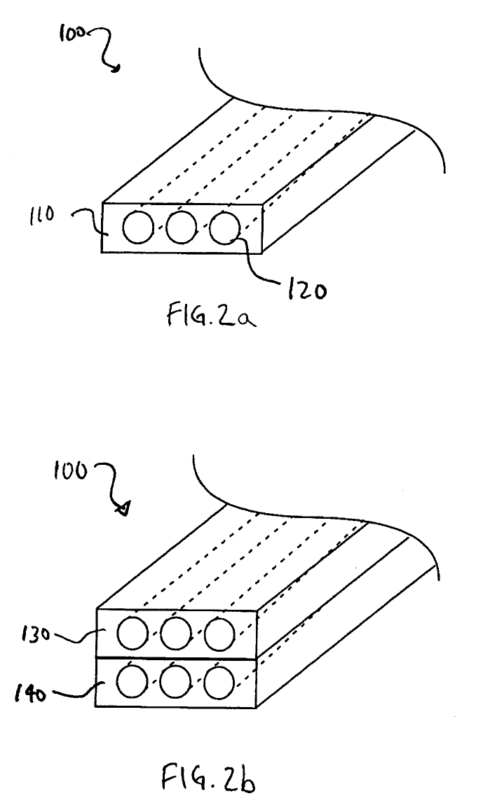

FIG. 2a illustrates a cut-away perspective view of an embodiment of a vertical or horizontal band 20 or 40, generally indicated at 100. Specifically, FIG. 2a illustrates a band 110 made of a flexible yet resilient material, such as a stiff rubber. The rubber can be resistant to ultraviolet light damage, and have suitable material properties to resist damage from wide temperature fluctuations. Additionally, the rubber can encapsulate reinforcing cords 120, such as nylon fibers, for added strength, stiffness and resiliency. Any number of reinforcing chords or fibers may be used in the rubber. FIG. 2b shows a composite band with a first band segment 130 affixed to a second band segment 140. The multiple band segments can add stiffness to the lifting basket, provide additional resiliency, and increase the band's propensity to maintain the lifting baskets original shape.

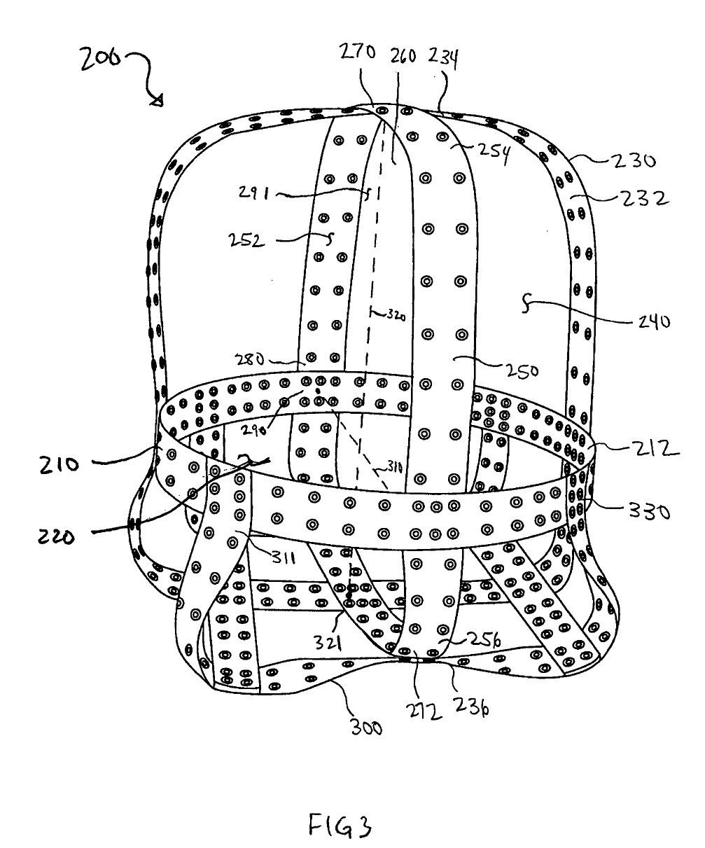

FIG. 3 illustrates a perspective view of another embodiment of a cable lifting basket, generally indicated at 200. Specifically, FIG. 3 illustrates a horizontal belly band 210, having an inside surface 212, and a space 220 within the inside surface. A first vertical band 230, having an inside surface 232, can be fastened to the belly band so that a space 240 is formed within the inside surface 232. A second vertical band 250, having an inside surface 252, can be fastened to the belly band and the first vertical band, so that a space 260 is formed within the inside surface 252. The top 234 and bottom 236 of the first vertical band can orthogonally intersect the top 254 and bottom 256 of the second vertical band. The first and second vertical bands 230 and 250 can be attached together at the top point of intersection 270 and the bottom point of intersection 272.

The belly band 210 can orthogonally intersect the first vertical band 230 and the second vertical band 250 and surround the first and second vertical bands at a middle location 280. The belly band can be attached to the first and second vertical bands at the points of intersection 290 in the middle region.

Skid bands 300, having a first end 311, a middle attachment location 321 and a second end 330, can be coupled to the belly band 210 at the first end, coupled to the bottom 256 of the first vertical band 250 at the middle attachment location, and coupled to the belly band at the second end. A horizontal reinforcing member 310, such as a chain, can be attached to at least two points on the inside surface of the first vertical band so that the chain crosses the space inside the vertical and belly bands. A vertical reinforcing member 320 may also be provided to strengthen the lifting basket as described previously. Additional vertical or horizontal reinforcing members can be used as desired.

In another example embodiment, the system and method of the present invention can include a lifting basket for lifting and moving the power cable of an electric mining shovel with the claws on the shovel's dipper bucket. The basket can have a horizontal belly band coupled to at least one vertical band such that a space is formed within the bands large enough to receive a claw of the shovel's dipper bucket. Because all the claws typically protrude from the bucket in the same direction, a basket having multiple vertical bands oriented at different angles with respect to one another can facilitate engagement with the shovel claws.

The band material can be a heavy rubber material surrounding nylon fibers that reinforce the band strength. The bands can have multiple layers of band material for added strength.

Horizontal chains can be attached to the bands and stretch across the space within the bands in order to maintain the horizontal shape of the lifting basket and prevent the lifting basket from collapsing under its own weight. A vertical chain can be attached to the top and bottom of the vertical band or bands and aid in maintaining the vertical shape of the basket when a heavy cable is lifted. Skid bands may be placed on the bottom of the basket that allows the basket to be pulled along the ground. The skid bands may extend from the belly band on one side of the basket to the belly band on the other side of the basket, and run parallel to, but on either side of, a vertical band. The skid bands may also be oriented in other directions. All the bands can be joined together by suitable fasteners, adhesives, or welding techniques as generally known in the art.

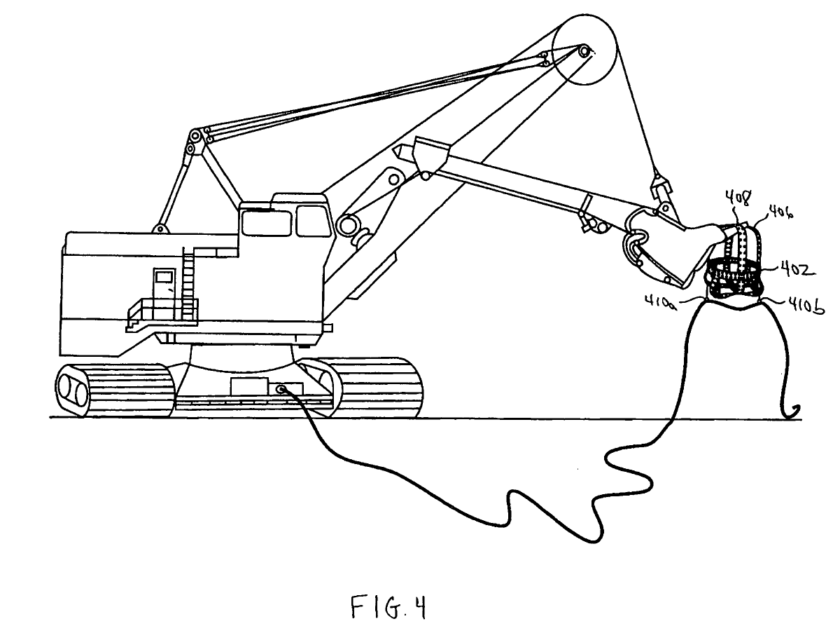

FIG. 4 of the drawings illustrates a side view of the present invention being used by a power shovel. Specifically, FIG. 4 illustrates the transportation of a power cable with an electric mining shovel using the cable lifting basket. The basket is a flexible carrier suitable for moving heavy power cables and can withstand severe environmental conditions of an open pit mine. It comprises a horizontal belly band 402 coupled to multiple vertical bands 406 and 408 which are arranged at different angles to facilitate engagement with the protruding claws of the shovel's dipper bucket. The horizontal and vertical bands are comprised of a flexible, resilient material such as rubber and can be several layers to add stiffness and increase strength. As the basket is hoisted upward, horizontal chains (not shown) which are connected to the vertical bands help maintain the shape of the basket and prevent it from collapsing or stretching.

The power cable can be configured to slide through protruding loops or cable grips 410a and 410b. The cable grips are coupled to the vertical band below the belly band which enables convenient cable transportation. The two cable grips which are located at opposite sides of the apparatus aid in equally distributing the weight of the electric power cable. Any number of cable grips can be used to secure the cable and various fasteners known to those skilled in the art may be used for cable grips.

The present invention can be manufactured using the following efficient method. The method for making a power cable lifting basket can include the operation of cutting a reinforced rubber belt into longer segments and shorter segments. Another operation can be overlaying similar length segments to form a thicker band. A further step can be joining one end of the thicker band to the other end to form larger and smaller continuous bands.

Once the base bands have been created, then the larger continuous band can be suspended in a vertical orientation. Next, the smaller continuous band can be attached at an intermediate location on the vertical band, orthogonal to the vertical band. In particular, the shorter band is in a horizontal orientation. Then a cable grip can be attached to a band.

In another manufacturing method embodiment for making a power cable lifting basket, the method can include suspending a second larger continuous band in a vertical orientation, wherein the top and bottom of the band orthogonally intersect the first vertical band. Then the second vertical band can be attached to the first vertical band at the point of intersection. Furthermore, the second vertical band can be attached to the horizontal band at the intermediate point of intersection.

If desired, the skid bands can be attached using the following method. For example, one end of a non-continuous skid band can be attached to the horizontal band. In addition, the skid band can be attached to the first vertical band at an intermediate location of the skid band, near the bottom of the vertical band. The other end of the skid band can also be to the horizontal band on the opposite side of the vertical band from the first end.

The present invention is valuable because it provides a valuable power cable lifting device for an electric mining shovel power cable. The present device can withstand substantial impact from the shovel dipper, the stress of repeatedly lifting a heavy power cable, and the severe environmental conditions of an open pit mine.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed:

1. A lifting basket, comprising:
a horizontal band, configured to maintain a space within the horizontal band;
a vertical band, coupled to the horizontal band so that a space is formed inside the vertical band;
a reinforcing member, coupled to at least two points of the vertical band, wherein the reinforcing member crosses the space inside the vertical band; and
a cable grip, coupled to the vertical band below the horizontal band.

2. A lifting basket in accordance with claim 1, wherein the reinforcing member crosses the space inside the vertical band in a plane substantially coincident with a horizontal plane of the horizontal band.

3. A lifting basket in accordance with claim 2, further comprising a second reinforcing member crossing the space inside the vertical band in the plane substantially coincident with a vertical plane of the vertical band.

4. A lifting basket in accordance with claim 1 wherein the band material includes multiple layers of rubber encapsulating nylon fibers.

5. A lifting basket in accordance with claim 1, wherein the vertical and horizontal bands further comprise:
a first segment of band material; and
a second segment of band material, coupled to the first segment of band material
so that the two segments together act as a single stiffer band.

6. A lifting basket in accordance with claim 1, further comprising a second vertical band, orthogonally intersecting the first vertical band, coupled to the horizontal band and the first vertical band so that a space is formed within an inside surface of the second vertical band.

7. A power cable lifting basket, comprising:
a horizontal belly band, having an inside surface, and configured to maintain a space within the inside surface;
a first vertical band, having an inside surface, the first vertical band being coupled to the belly band so that a space is formed within the inside surface of the first vertical band, the vertical band having a top and a bottom;
a second vertical band, having an inside surface, the second vertical band being coupled to the belly band and the first vertical band so that a space is formed within the inside surface, the second vertical band having a top and a bottom, the top of the second vertical band orthogonally intersecting the top of the first vertical band, the bottom orthogonally intersecting the bottom of the first vertical band;
a skid band, having a first end, a middle portion and a second end, the skid band being coupled to the belly band at the first end, coupled to the bottom of the first vertical band at the middle portion, and coupled to the belly band at the second end;
a horizontal reinforcing chain coupled to at least two points on the inside surface of the first vertical band so that the chain crosses the space inside the vertical and belly bands; and
a cable grip, coupled to the vertical band below the belly band.

8. A power cable lifting basket in accordance with claim 7, further comprising:
a second horizontal reinforcing chain, oriented orthogonally with respect to the first reinforcing chain, coupled to at least two points on the inside of the second vertical band so that the chain crosses the space inside the vertical and belly bands; and
a vertical reinforcing chain coupled to the top and bottom of the vertical bands at a point of intersection with the vertical bands.

9. A lifting basket in accordance with claim 7 wherein the band material includes multiple layers of rubber encapsulating nylon fibers.

10. A lifting basket in accordance with claim 7, wherein the vertical and horizontal bands further comprise:
a first segment of band material; and
a second segment of band material, coupled to the first segment of band material so that the two segments together act as a single stiffer band.

11. A method for making a power cable lifting basket comprising the steps of:
cutting a reinforced rubber belt into longer segments and shorter segments;
overlaying similar length segments to form a thicker band;
joining one end of the thicker band to the other end to form larger and smaller continuous bands;
suspending the larger continuous band in a vertical orientation;
attaching the smaller continuous band at an intermediate location on the vertical band, orthogonal to the vertical band, wherein the shorter band is in a horizontal orientation; and
attaching a cable grip to a band.

12. A method for making a power cable lifting basket in accordance with claim 11, further comprising the steps of:
suspending a second larger continuous band in a vertical orientation, wherein the top and bottom of the band orthogonally intersect the first vertical band;
attaching the second vertical band to the first vertical band at the point of intersection; and
attaching the second vertical band to the horizontal band at the intermediate point of intersection.

13. A method for making a power cable lifting basket in accordance with claim 11, further comprising the steps of:
attaching one end of a non-continuous skid band to the horizontal band;
attaching the skid band to the first vertical band at an intermediate location of the skid band, near the bottom of the vertical band; and
attaching the other end of the skid band to the horizontal band on the opposite side of the vertical band from the first end.
